(19) United States
(12) Patent Application Publication
(10) Pub. No.: US 2010/0131533 A1
(43) Pub. Date: May 27, 2010

(54) System for automatic organization and communication of visual data based on domain knowledge

(76) Inventor: Joseph L. Ortiz, Knoxville, TN (US)

Correspondence Address: ROBERT J. LAUF, 998 W. OUTER DRIVE, OAK RIDGE, TN, 37830, US

(21) Appl. No.: 12/592,303

(22) Filed: Nov. 23, 2009

Related U.S. Application Data
(60) Provisional application No. 61/117,794, filed on Nov. 25, 2008.
(60) Provisional application No. 61/117,804, filed on Nov. 25, 2008.

(51) Int. Cl. G06F 17/30; G06F 3/048

(52) U.S. Cl. 707/758; 715/852; 707/E17.041

(57) ABSTRACT

A computer-based system enables the creation of a time series based sequence of observations of a selected object. Each observation consists of a predefined, fixed set of standardized object views from which metadata about the visual data can be automatically determined and associated with the views. A set of standardized views and associated metadata, captured in an observation at a point in time, enables comparison of changes to a specific object over time on a view-by-view basis, or changes to a specific object over time in comparison to second reference object of the same type as the first object on a view-by-view basis. Metadata about the object in the domain are organized and made available in the domain specific processing system to support visual search, retrieval, analysis, and decision making by users within the domain.

### CROSS REFERENCE TO RELATED APPLICATION

This application claims the benefit of Provisional Application Ser. No. 61/117,794 entitled, “Method and apparatus for automatic organization and communication of images on domain knowledge for exploitation by domain-specific users with longitudinal image change annotation” and Provisional Application Ser. No. 61/117,804 entitled, “Method and apparatus for automatic organization and communication of images on domain knowledge for exploitation by domain-specific users,” both filed by the present inventor on Nov. 25, 2008; it further contains material disclosed in part in U.S. patent application Ser. No. 11/934,274 entitled “Method and apparatus for skin documentation and analysis,” filed by the present inventor on Nov. 2, 2007. The entire disclosures of each of the foregoing documents are incorporated herein in their entirety.

### BACKGROUND OF THE INVENTION

1. Field of the Invention

The invention pertains to the field of visual documentation search and retrieval in support of decision making and more particularly to methods for allowing digital visual information of real world objects to be systematically captured, organized, analyzed, and communicated for time-based search, retrieval, and comparative analysis and decision making.

2. Description of Related Art

Visual information is dense. The adage that a picture is worth a thousand words is well known. When used as a tool for data collection and documentation, a picture or a video can quickly and with a high level of detail capture the as-is status of an object. Visually documenting an object can capture color, geometry, composition, relative position, shape, and texture. Compared with capturing details using the written word, a hand drawn illustration or a verbal dictation, capturing a picture or a video will significantly speed documentation workflow and provide high fidelity information to support real-time or forensic analysis and decision making about the object. Visual documentation benefits are realized whether the data is collected as visible light, infrared light, ultraviolet light, or any other single or multiply combined ranges of the electro-magnetic spectrum.

Capture of data to support making decisions is well known. Capturing visual data to support decision making is an emerging field. Decision support systems provide a framework that enables data from disparate information sources to be collected, integrated, and analyzed. They provide a higher level of situational awareness within a particular domain of application, and to thus enable the making of better decisions about things of interest within the domain. Decision support systems enable status monitoring for key objects of interest, and improving pro-active decision making. Decision support systems enable different users within the domain to create, access, and analyze information based on privilege rights.

To effectively use visual data for decision support requires a systematic approach to the collection, annotation, and organization of that visual data. Sensors capable of capturing visual data are being incorporated into an increasing variety of devices, including not only digital still photography cameras and digital video cameras, but computers, cell phones, PDA, organizers, web cameras, security cameras, automobiles, and a wide range of scientific instrumentation, to name a few. This visual data sensor proliferation has created an explosion in the amount of visual data being generated and stored for short term and long term use. Unfortunately support for visual data organization is not a feature of commercial off-the-shelf visual sensor based devices.

Without an over-riding procedure for organization, the result is large or very large collections of unstructured visual documentation data. Unlike the written word, which can be readily analyzed and processed for purposes of search and retrieval, raw visual documentation data has no direct correspondence with the meaning or contents of what is actually captured in the visual data. A page of text with the words “boy” and “dog” and “ball” clearly has something to do with a boy, his dog, and a ball. An image of a boy throwing a ball to his dog consists of potentially tens of millions of colored pixels, each with red, green, and blue color intensity values that say nothing directly about “boy”, “dog”, or “ball”. As more and more visual data is collected, it becomes more labor intensive to sort, analyze, and store images in an easy to search and access format. This problem manifests itself on an individual basis, whether the individual is capturing images for personal use or capturing images as a step in a procedure that is employed in a professional, commercial, educational, or healthcare endeavor. In all cases, images (whether from a digital camera, video camera, an X-ray, a nuclear imaging device (CT, MRI, PET), or other imaging sensing device) are intended to be used for visual communication of events, objects, or people. Accessing the images for a particular use in order to communicate with one or more other individuals is a challenge when images cannot be easily retrieved due to complexities of access and organization.

It is well known that visual data, whether it is single photo, a collection of photos, a video clip or movie, or a collection of video clips or movies, will require metadata in order to make the visual data searchable. Metadata is defined as data about data and its use is well known for facilitating indexing items in a database. Extracting metadata from visual data to facilitate indexing is much more difficult since the meaning and logical content of what's in this visual data sample is not explicitly contained in the data set.

Some forms of metadata can be explicitly extracted from visual data. For example, visual capture device that is combined with a global positioning system (GPS) sensor can create visual data with a header in which the GPS location is stored. A visual data collection with GPS metadata enables the automatic identification and selection of specific visual data views that match a specific location, plus or minus some distance. Association of GPS metadata with visual data also enables data about the specific GPS location to be accessed and used for metadata tagging or otherwise organizing the visual data. In another example, a single visual capture device monitoring a location for the purposes of security and surveillance will generate a sequence of samples of that fixed location over time. Any objects that appear or events that take place within the field of view of that visual sensor can be detected. The timestamp of each visual data frame can be treated as metadata for searching through the visual data and automatically identifying when a change takes place.

Various solutions have been developed to create, extract, and associate metadata with collections of visual data in order to make those collections searchable. These systems rely on the following approaches to make visual content searchable.
1. A user interface provides a human with the ability to tag visual data with metadata. This can be done manually, or aided with various techniques to speed the process such as pre-populated metadata lists, pull down selection menus, automated metadata suggestions offered based on visual data similarity to other known objects.
2. Analyze individual visual data frames to create metadata based on what is pictured in the frame. Individual frames can be analyzed at a ‘low level’ whereby the individual visual data picture elements (pixels) are plotted, or sorted, counted, or analyzed for mean, variance, or various other mathematical or statistical measures. Regionalized distribution of pixels within a single frame can be used to identify known objects like blue-sky, green grass, white sand, etc. Individual frames can also be analyzed at a ‘high level’, whereby various filters or transformations are applied to the entire visual data frame. High level processing can identify lines, groups of lines, parallel lines, regions that are separate, or that are contained by other regions, or that contain sub-regions. Using very specialized rules, low-level and high-level processing can then be used to infer the nature of what is depicted in the visual data, and metadata tags can be assigned to the visual data as a result.
3. Analyze multiple visual data frames to group ‘related’ frames together. Two cases are known. If the first, single visual data frames in a collection are analyzed for similarity. In the second case, a sequence of visual data frames is analyzed. For the first case, analysis results generated from the low-level and high-level processing detailed in #2 is used as the basis of comparing other unrelated visual data frames. This type of search can be used for example to find all pictures of the beach (blue pixels for sky on top of white pixels on the bottom for sand). In another example, a collection can be searched for all visual data frames that have a capture time-stamp at a certain time, plus or minus some window. This would result in visual data that potentially were captured at the same location or for the same event or purpose. Other visual data capture device metadata, including shutter speed, aperture, ISO-level, or focal length can be used as well to group ‘similar’ visual data. Similarity processing can take place for visual data frame sequences. For example in a movie, multiple visual data frames will be captured within a scene. Background details, again as obtained from the low-level and high-level processing detailed in #2 can be used to identify and segment one scene or different shots in a scene. In the case of a movie, the timestamp for each frame is relative to the start time “0” for the beginning of the movie. But the timestamp can be used as a metadata index into the visual data content.

These solutions can be applied individually or in various combinations to create visual data search indexing metadata. These solutions work with consumer or commercial collections of photography, a video clip or movie which consists of a series of shots, scenes, or chapters, or mixed collections of photos and or video clips or movies.

Unfortunately, these solutions are either unreliable or extremely labor intensive. Without an overriding data-driven capture procedure or human intervention, organizing large collections of unstructured visual data is at best a guess and a question of probability of accuracy. Programmatic analysis of digital visual frame data has yet to develop to a level of accuracy and consistency comparable to human perception and identification. Solutions which rely on comparative analysis are also error prone. Assuming that metadata from a known, previously analyzed visual data frame can be used for a ‘similar frame’ will always be limited to a probabilistic level of accuracy.

The existing metadata based methods for facilitating visual data search and retrieval do not provide an effective approach to enable use of visual data to support decision making.

Therefore, what is needed is a system that enables the automated collection, organization, processing, analysis, and communication of visual data captured documenting observations of an object over time in order to provide visual search, retrieval, analysis, and decision making.

### OBJECTS AND ADVANTAGES

Objects of the present invention include the following:

providing a system that automates the organization of time-based visual data serial observations of a uniquely identified object within a specific domain, enabling the capture, organization, analysis, and communication of the serialized visual data observations of the object for use by individuals who are members of a community of users that are within the particular domain of application;
providing a system that enables visual data based support, including determining, analyzing, and reporting (communicating) on the current status of an object or group of objects, and determining, analyzing, and reporting (communicating) on the forensic status and changes to the object;
providing a system that enables visual data based decision support, including determining, analyzing, and reporting (communicating) on the current status of an object or group of objects compared to a reference object, and determining, analyzing, and reporting (communicating) on the forensic status and changes to the object compared to a reference object;
providing a system that employs a standardized visual data capture workflow to enable standard views of the object to be captured by one of a variety of possible visual observation devices, and enabling the automatic association of metadata about the object to be collected;
providing a system that allows a domain specific information processing system to be enhanced with visual data and metadata that is automatically captured and organized in support of domain specific decision support;
providing a system to organize, analyze, and communicate visual data and metadata in a manner that allows the user community members to use the visual data for status reporting, change determination, and decision making; and,
providing a system to organize visual data for a specific object according to attributes including observation time, observation view, descriptive keywords, annotations, spatial attributes, or other information that provide domain specific meaning and interpretation to the content of the visual data; providing a system to enables the searching, retrieval, annotation, and comparative analysis of visual data from a time series based collection of visual data observations of a uniquely identified object or comparative reference object of the same type.

These and other objects and advantages of the invention will become apparent from consideration of the following specification, read in conjunction with the drawings.

### SUMMARY OF THE INVENTION

According to one aspect of the invention, a method for organizing visual data comprises the steps of: defining a workflow structure; capturing a series of views; associating each view with metadata, wherein the metadata includes data derived from a comparison of the views and their associated metadata at selected points in the workflow; and, creating a searchable database of the metadata.

According to another aspect of the invention, a method for user retrieval of visual data, comprises: searching a database, wherein the database comprises: a series of views, and metadata associated with the series of views, wherein the metadata includes data derived from a comparison of the views and their associated metadata at selected points in said workflow.

According to another aspect of the invention, a method for analysis of visual data comprises the steps of: searching a database, wherein the database comprises: a series of views, and metadata associated with the series of views, wherein the metadata includes data derived from a comparison of the views and their associated metadata at selected points in the workflow; selecting at least two views and their associated metadata; and, comparing the at least two views and their associated metadata in order to derive useful information therefrom.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore non-limiting embodiments illustrated in the drawing figures, wherein like numerals (if they occur in more than one view) designate the same elements. The features in the drawings are not necessarily drawn to scale.

FIG. 1 is a schematic Illustration of an exemplary integrated visual data organizing system for carrying out an example of the invention;

FIG. 2 is a schematic diagram depicting the primary components of a system controller for carrying out one example of the invention;

FIG. 3 is a schematic diagram of workflow structure data elements used by an example of the invention to represent information about a time series data collection for views and associated metadata of a single object, with two distinct observation events, and the associated metadata for the time series.

FIG. 4 is a schematic diagram of the workflow structure data elements used by an example of the invention to represent information about a time series data collection for views and associated metadata of a single object, with an arbitrary number “i” of distinct observation events, and the associated metadata for the time series.

FIG. 5 is a schematic diagram detailing the procedure used to search for an existing object and its time series views and associated metadata, or to create a new object and object time series views and associated metadata if no such object-specific time series exists.

FIG. 6 is a schematic diagram detailing the procedure used to capture the visual data observations, including one or more visual data views and associated device metadata of an object for a single observation event, with post processing if required, to create one or more derived subset or virtual output views and associated metadata.

FIG. 7 is an illustration of some possible options for visual object view and associated metadata comparison to support visual decision making.

FIG. 8 is a procedure overview of the exemplary algorithms that may be utilized for the analysis of an object time series view and associated metadata collected at a point in time compared to second object time series view and associated metadata collected at the same or different point in time.

FIG. 9 is an illustrative diagram showing several options for devices used to capture one or more views in the workflow structure that relies on a single imaging device operating sequentially, under manual control.

FIG. 10 is an illustrative diagram showing several options for devices used to capture one or more views in the workflow structure that relies on a single imaging device operating sequentially, under programmatic control.

FIG. 11 is an illustrative diagram showing several options for devices used to capture one or more views in the workflow structure that relies on a multiple imaging devices operating substantially simultaneously, under programmatic control.

FIG. 12 is an illustrative diagram showing several options for devices used to capture one or more views in the workflow structure that relies on an imaging device that captures a single large image view from which view areas that are a subset of the larger image view may be derived.

FIG. 13 is an illustrative diagram showing several options for devices used to capture one or more views in the workflow structure that relies on an imaging device that captures a 3D data set from which virtual view areas that are a subset of the 3D data set may be derived.

### DETAILED DESCRIPTION OF THE INVENTION

### Introduction

In the following description of the invention, references are made to the accompanying diagrams and drawings, which form a part thereof, and in which is shown by way of illustration a specific example whereby the invention may be practiced. It should be understood that other embodiments may be used and structural changes may be made without departing from the scope of the present invention.

Use of visual documentation is increasing with the proliferation of sensors that capture visual data. While the simplicity of capturing visual data has increased, and the costs associated with capturing visual data has decreased, the means with which visual data is organized and put to use for the purpose of documentation and decision support has not significantly improved in terms of simplicity or cost.

The invention provides a computer-based system that enables the creation of a time series based sequence of observations of an identified object, where each observation consists of a predefined, fixed set of standardized object views from which metadata about the visual data can be automatically determined and associated with the views. A set of standardized views and associated metadata, captured in an observation at a point in time, enables comparison of changes to a specific object over time on a view-by-view basis, or changes to a specific object over time in comparison to second reference object of the same type as the first object on a view-by-view basis.

Further, observations are made of an object of a certain type in a specific domain. Metadata about the object in the domain are automatically known a priori, as a direct result of the workflow structure used to visually document the object, and as a result of comparative analysis. Metadata about the object is obtained by 1) either direct or indirect database lookup reference based on the object type; 2) from the object or the object-type definition hierarchy within the domain; 3) a particular observation view of the object at a certain point or period in time; 4) the workflow structure capture steps for documenting the object; 5) preset or generated parameters of the visual data capture device; 6) derived views created based on configuring or processing visual or 3D data captured by the visual data capture device; 7) manual or automatic entry by the domain data user as view annotations; 8) other data creation or storage devices linked or associated programmatically or via a database to the view, and; 9), from the comparative analysis of the new visual data to previous similar views of the same object or reference object from the past. The workflow structure enables views and their associated metadata to be organized and made available in the domain specific processing system to support visual search, retrieval, analysis, and decision making by users within the domain.

The present invention takes advantage of the fact that large volume of visual data captured by an individual are clustered into a specific application domain. For example, a real estate agent capturing photographs to support the sale of residential or commercial property will take tens or hundreds of pictures a week of houses or buildings. A dermatologist offering cosmetic services to patients will take tens or hundreds of photographs a week of faces, torsos, backs, legs, or arms for example. A dentist may take dozens of x-rays of patient's teeth a week. A corrections officer monitoring incoming inmate population affiliations with organized crime may take tens or hundreds of photographs of inmate tattoos a month. An accident investigator may use a video camera to walk around a scene, capturing documentation of damaged vehicles, or property damage. In each of these applications, the visual content is specific to a particular domain. In each of these applications the visual documentation captured will generally consist of the same collection of views for the same type of object.

The invention further takes advantage of the specific domain requirements for visual data capture, creating a repeatable workflow structure, including a workflow capture procedure and workflow data structure for time series based visual data views, from which metadata can explicitly and automatically be associated with captured visual data. Metadata generated by the invention is non-ambiguous due to the procedural workflow structure approach taken in collecting and generating descriptive metadata for the specific object in a specific application domain. For example, the real estate agent documenting a house may use a standardized workflow structure and sequence of views, including street view, front yard, front door, foyer, living room, kitchen, master bedroom, and so on. A dermatologist documenting a baseline of total skin photography of a patient at high risk for melanoma may take use a standardized workflow structure and sequence of views, including, face-front, face-left, face-right, neck, torso, left arm, right arm, etc. An insurance appraiser may document damage to a car using a standardized workflow structure and sequence.

As used herein the term workflow structure or workflow procedure means a series of views that have some relationship to each other. This may include multiple images of the same view at different times, or it may include different views or views from different positions of a single object at one particular time. Furthermore, it may include different views of a single object and one or more views of a reference object having similar properties.

As used herein, the term views includes digital images generated by any suitable imaging process, which may include fixed cameras, moving cameras, scanners, devices with embedded imaging sensors, and medical imaging devices. Furthermore the term views includes data captured in the visible light spectrum, data captured outside the visual light spectrum, and includes infrared light, ultraviolet light, or any other single or multiply combined ranges of the electro-magnetic spectrum. Furthermore, views may be generated or calculated virtual views derived from imaging systems or 3D data sets. It will be understood that this includes without limitation, volumetric data derived from medical imaging systems, stereo imaging systems, laser imaging and photo-imaging systems, computer rendered models, or various other devices that capture 3D data sets.

Further, this invention enables the automatic processing of one or more visual data views captured during a single object observation event in order to document one or more derived views. For example, a real estate visual data capture workflow procedure that captures fisheye-lens based two shot panoramas may for each step, capture two source views for each step of the capture workflow procedure. Once the capture workflow procedure is complete, the source data can be automatically processed to create a resulting derived view. So in this example, the two source views of the street view, the front yard, and so on can be stitched together to create the street view panorama, the front yard panorama, and so on. Further the workflow structure capture procedure can specify the first source view is centered on the house and the second source view on the street. Metadata about what is captured in each of these source views can be automatically associated with the source views and the resulting derived view. This metadata about the house view and street view can further facilitate the automatic processing to further create extracted sub-views and associated metadata extracted from the house view subset and street view subset of the panorama. These steps, the processing, the view type, the output types, etc. are well known in the context of the domain, the object in the domain, and the procedure employed for visually documenting the object using multiple pre-defined views.

Further, the invention takes advantage of the ability to group and automatically tie together a series of time-based observations of a uniquely identified object. Because the invention operates within a particular domain, knowledge about objects of interest within the domain provides metadata that can be automatically associated with a specific instance of the object type. For example, a dermatologist capturing a total skin photography procedure of patient A may capture that defined sequence at different times. Since each step of the procedure is standardized, the invention enables the automatic association of metadata related to changes in each step of the observations for that particular patient over time.

Further, the invention enables the automated detection, identification, and recognition of changes in an object over time. In particular, based on the standardization steps employed in the capture of visual data views, the same view of an object taken over time can be used to perform a comparative analysis. Further, due to the use of domain specific metadata about the object being visually documented, the invention enables comparison of objects within the domain of the same type. A baseline or reference object of Type “A” can be compared to another, distinctly unique object, also of Type “A” for relative differences. Comparison of the first and second object of Type “A” can be performed with one or more reference visual data views provided over time comparing the baseline object to the second.

As noted above, what also is needed is a system that enables all individuals within the application domain who have a need or desire to search, retrieve, access, edit, delete, view, and utilize information contained in the visual documentation to be able to do so, as permitted and needed within their particular application. A real estate agent will want to provide a display of all homes that meet a certain criteria to an individual on the market for a new home. The patient of a dermatologist who has completed several cosmetic procedures may want to review and share before and after images of the procedures with a friend who is contemplating undergoing the same procedures. A criminal investigator may need to review the range of tattoo markings while researching a crime involving a gang member, or track tattoo changes made to a specific inmate while incarcerated, or during an extended period of time both in and out of incarceration. In each of these applications, the access to and exploitation of the visual content within the community of domain specific users can be enhanced by a system that automatically analyzes, organizes, and communicates visual data, organized in a time series, and organized by a unique identifier that separates out visual data for one object from another. Such a system takes a comprehensive approach to creating, tracking, and organizing metadata that is associated with a series of visual data taken together, and the metadata associated with each visual data sample in the series.

Visual data organized by the invention becomes searchable in a variety of ways. Processing by the invention enables searching of visual data views, metadata associated with the visual data views, or a combination of the two. Analysis of visual data views and associated metadata stored in the organized visual data database as well can be performed on visual data views, metadata associated with the visual data views, or a combination of the two. Some uses of the searchable database of metadata include the following:
perform per-view analysis, either manual or programmatic, to create new metadata information about the view;
find all image views of a particular type (males under 25 with moles; car doors with dents);
find all image views with a particular feature specification (males under 25 with moles >2 mm in size; car doors with dents >20 cm in size);
list the dates and object details for objects that have which changes in their appearance (males under 25 with any skin changes; car doors that have been dented); or,
perform a statistical analysis on prevalence of some condition without retrieving the actual images.

Knowledge about the domain combined with the workflow structure organizes the visual data views, based on the association of metadata with the visual data views, and allows visual data storage, retrieval, and analysis to be automated. Because of these aspects of the invention, visual data views and associated metadata of objects within a domain can be made available, with corresponding detailed and time sequenced metadata about changes in the object, thereby enabling a previously unavailable comprehensive approach to the utilization of visual data for search, retrieval, analysis, and decision making.

General Overview

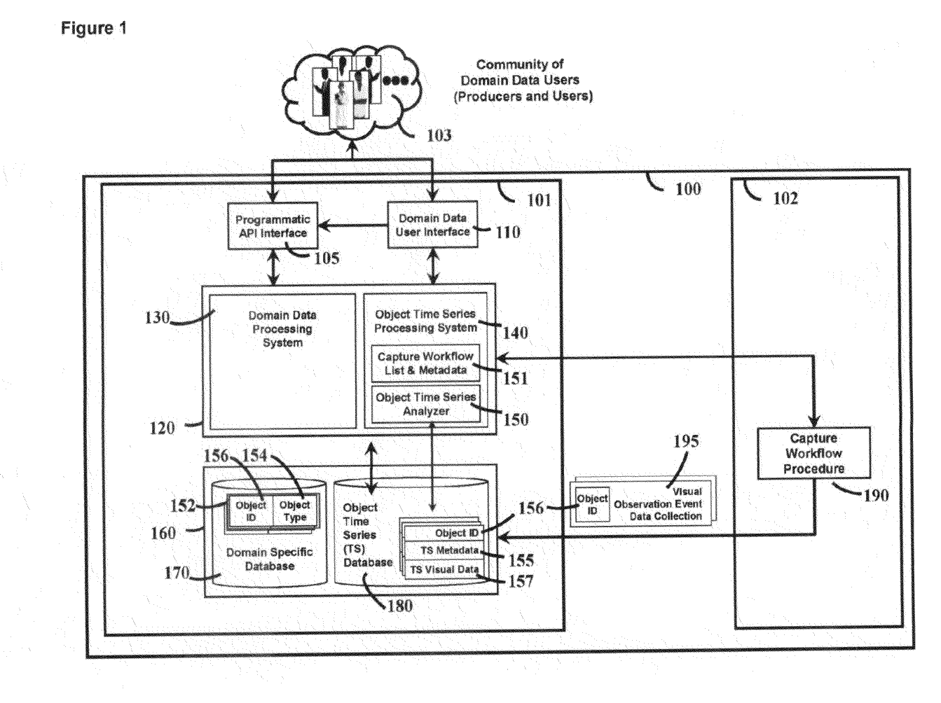

FIG. 1 is a schematic Illustration of an exemplary implementation of a system that automatically captures and organizes and analyzes visual data of an object in a specific domain of application, for search, retrieval, and decision support by users within that domain 100. Referring to FIG. 1, users 103 of the system are members within the domain of application and are separated into producers and users of the visual documentation data that are captured, organized, analyzed, and communicated by the system. Either the producers or the users of the domain data will use the system to analyze visual data in support of domain-based decisions.

Domain data users will create objects within the system using the domain data interface 110. A new object is assigned a unique Object-ID 156. Each object created in the system will be of a specific Object-Type 154. The Object-Type metadata field is used to identify similar objects, defined to be objects of the same composition, objects of the same model, or instances of the same object definition. It will be appreciated that using data modeling approaches Object-Type can be not only a single type identifier, but an instance in an object hierarchy with inheritance and other object-oriented data modeling relationships. The object hierarchy based data model enables the metadata generation based on the comparison of one Object-Type instance from another. Domain specific data detailing the nature of, the features of, and key decision making aspects of the object of type Object-Type are contained in the domain specific database 170, and provide the object-specific metadata 305 used in time-series organizing and time series analysis 150 of the visual data views to support of visual search, retrieval, analysis, and decision making.

A visual data producer will use the system to create or update an object time series data collection for a single, uniquely identifiable object. The visual data producer will use a capture workflow procedure 190 to generate a new visual Observation Event (OE) Data Collection 195 of the specified object at a specific point in time.

Over time, the visual data observation time series of all the uniquely identified objects are maintained and organized automatically by the system, enabling domain data users and producers to access the object time series visual data 157, the associated metadata 155, indexed by the Object-ID 156 within the object time series database 180. As well, elements in the object time series database 180 can be accessed in combination with other domain specific data related specifically to the object 170. Domain data users, including either the visual data producers or the visual data users, can use the system to perform object time series analysis for one or more uniquely identified objects 150. Data generated as a result of the object time series analysis 155 becomes additional metadata that can be used to support visual search, retrieval, and status and change analysis and determination for decision making about the object in the visual data time series.

More specifically in FIG. 1, the domain data users access the system via a domain data user interface 110. The interface is optimized for the application within the particular domain, enabling both of those features and functions specific to data processing within the domain 130 as well as those directly related to the object time series capture, organization, analysis, and communication 140 and 150 to support visual search, retrieval, analysis, and decision making. Visual data is presented through the user interface in the manner most appropriate, whether the object view data is single visual data view of picture data, multi-frame video or movie data presented as a sequence of visual data views, 3D geometry based data with possible photo-texture map presented as a user-controllable view display, panoramic data presented as a user-controllable view display or defined set of individual derived views, or other form of visual data representation. The domain data interface may be used to command an automated operation of the system 100 via interface to the programmatic API interface 105. The programmatic API interface also allows the entire system to be embedded as a subsystem of a larger system, exposing the entire feature set of the system 100 for programmatic control. The user interface, in combination with the domain data processing system is responsible for identification of each user of the system and ensuring user data security privileges are defined and enforced. The user interface is also responsible for invoking the processing system 120 to provide the users of the system with domain data and domain data object time series search, retrieval, analysis, and communication functions 500, editing functions, new object creation functions 500, remote control of time series data workflow procedure 190 in conjunction with an computer-based API 605 as opposed to through a local device human control user interface 605, data communication functions, data retention, backup, and recovery functions, and other functions as may be needed to capture, organize, analyze, and communicate domain data, both visual and other, and to maintain the operational status, quality, and integrity of the visual view data and associated metadata.

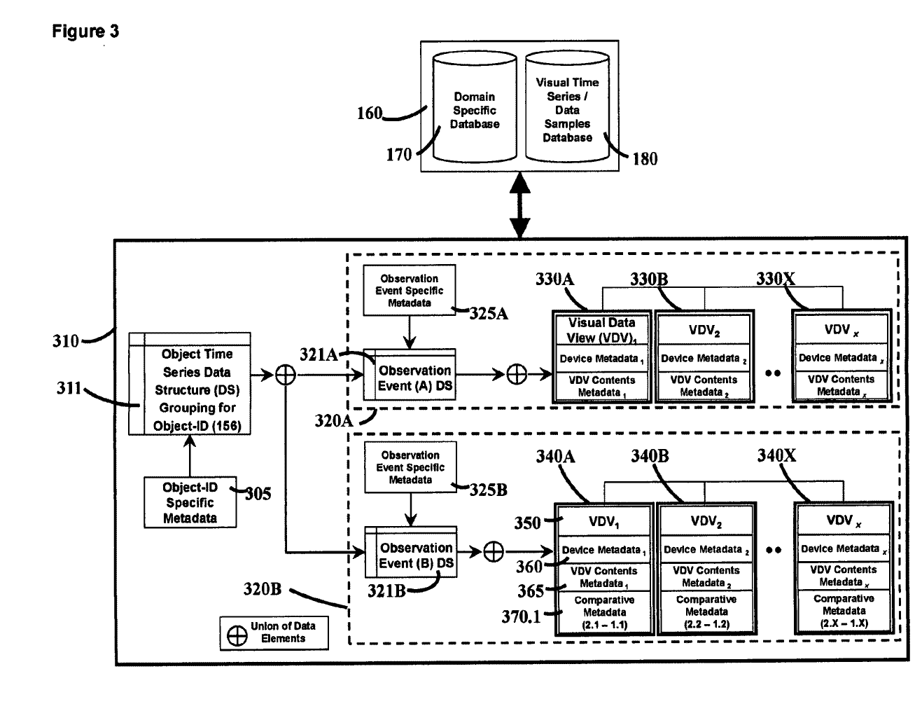

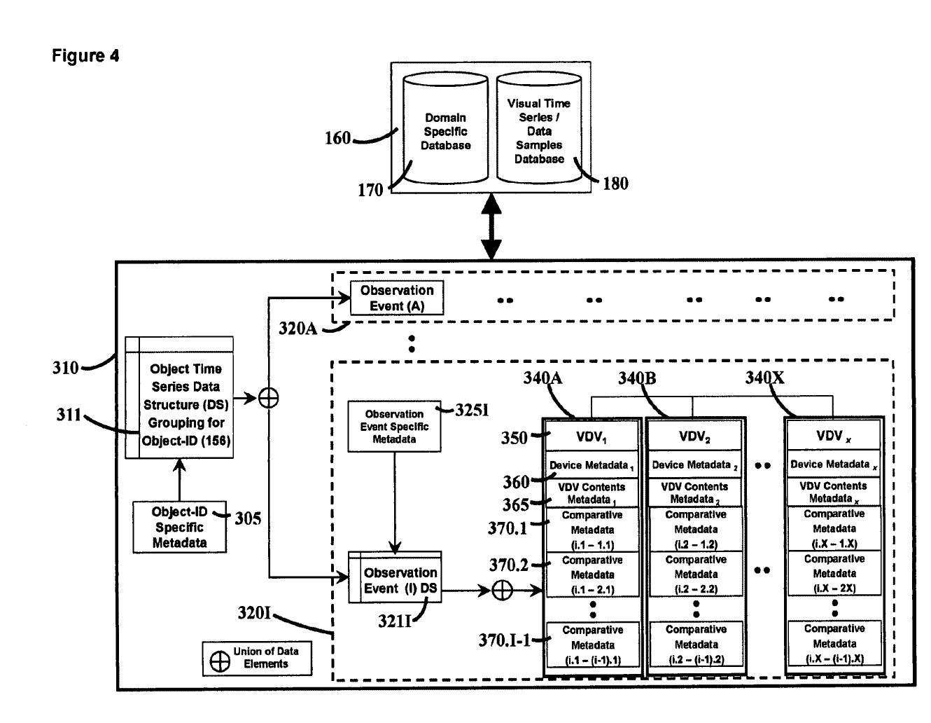

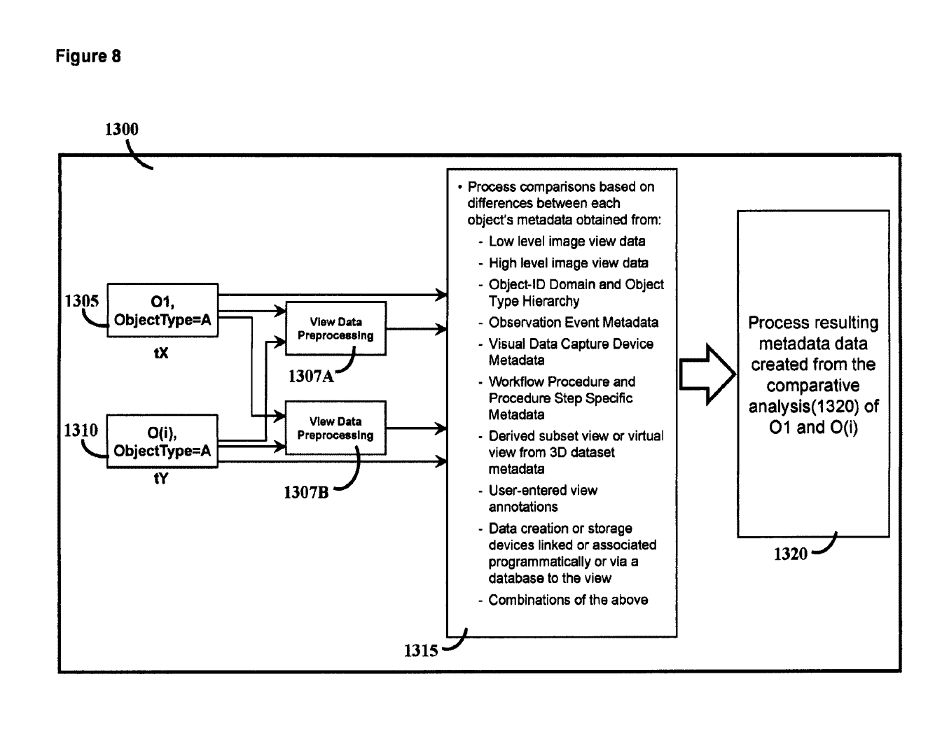

Processing performed by the system 120 takes place on stored data 160 that can be either domain specific data not specifically related to object visual time series view and metadata data 170, or object visual time series view and metadata data itself 180. Visual data captured by the capture workflow procedure 195 is stored in the object time series database 180 and analyzed either in real-time or as a post-processing procedure step by the object time series analyzer 150. All object series data is stored in the database 180 with the data format elements detailed in FIGS. 3 and 4. One or more object data series data collections are stored in the database 180. All object series data is analyzed with algorithms types detailed in FIG. 8.

The capture workflow list and metadata 151 is shown located in the object time series processing system, but could in another embodiment be data stored in the object time series database 180, or in another embodiment stored as data in the capture workflow procedure device 102. The capture workflow list and metadata has at least one entry for each type of object defined in the system 100. The capture workflow list and metadata provides the step-by-step listing of steps needed to implement the reproducible sequence of views to be captured by the capture device 102. Each step has additional metadata defined that provides information about the view captured in a particular step of the procedure. More than one procedure may exist for a single unique object, but no time series object can be stored in the system with having at least one capture workflow list entry and metadata defined.

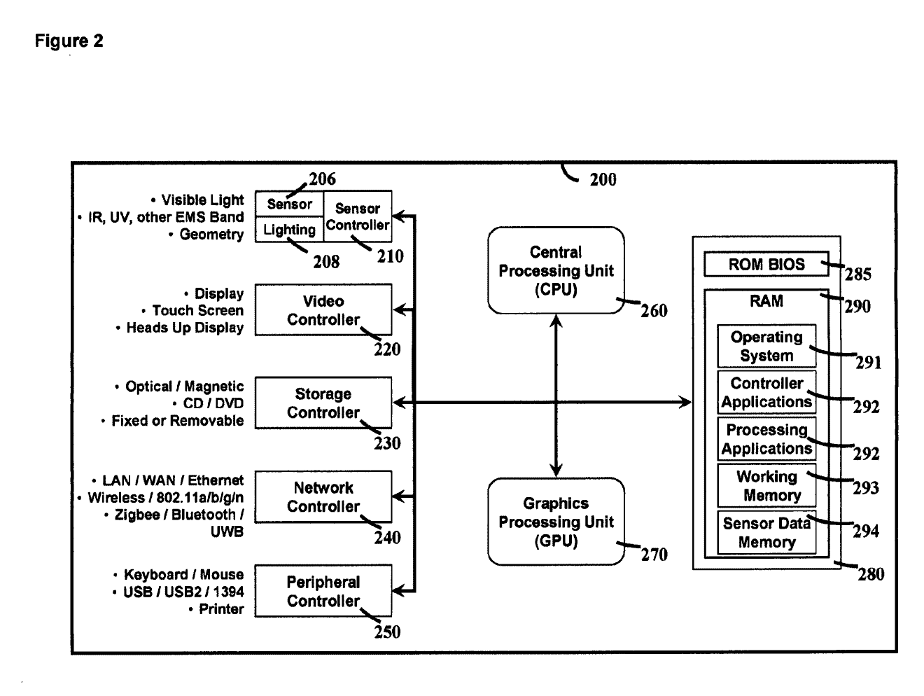

FIG. 2 is a schematic diagram depicting the primary components of a system for carrying out an embodiment of the invention. The system controller components show one of many possible examples of a computer controller configuration that may be employed for the invention. In particular, the components of the invention 100 may reside on one or more controllers 200. For example, in a single turnkey example, the invention can reside on a single system that includes the controller 200 providing the user interface 110, processing for domain data and object time series processing 120, with locally resident data for both 160, and with an integrated capture workflow processing device 190. Other possible examples may include separate controllers 200 for domain data processing and object time series processing and database data for both 101 separate from the device providing the integrated capture workflow processing 102. In yet another possible example, the user interface can be provided through an internet browser with a networked connection to the processing system 120, the databases 160, combined with a remotely controlled visual data capture device 102. It will be clear to practitioners in the art that the invention may be embodied in various arrangements, including stand alone implementation, networked implementation, implementation using internet based processing or internet based storage or both, as well as componentized into a parallel processing distributed computing system using large numbers of tightly coupled processors, or a distributed computing mesh using high-speed interconnection.

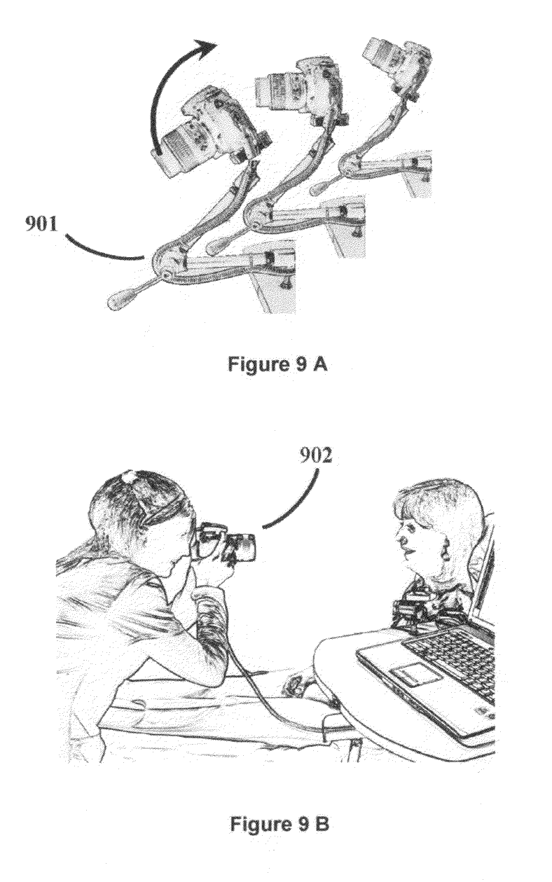

Referring to FIG. 2, while it will be clear to practitioners in the art that the invention may employ still photography cameras to capture single visual data view, or video cameras to capture a sequence of single visual data views, a key aspect of the invention is that the visual data capture device may be embodied in various additional arrangements in which the object time series data are collected 195, offering additional visual data input modalities that expand the range of options for visual search, retrieval, analysis, and decision making. Some capture devices are illustrated in FIGS. 9, 10, 11, 12, and 13. Each of these visual data capture devices may be implemented using one or more system controllers (200), stand alone or integrated with the other components of the invention (101).

Object visual observation view and associated metadata data may be acquired in real time (or near real time) by an visual data capture device tightly coupled to the processing system. Alternatively, data captured by a separate device providing the integrated capture workflow processing can output visual observation view and associated metadata data onto a removable media device 230 or communicated via network 240 to various possible locations for direct processing or post-processing as some later time. Finally, visual observation view and associated metadata data may be accessed via a query to a database 120 located locally or remotely for processing, analysis and communication.

FIG. 3 is a schematic diagram of the workflow structure specific data format for a time series data collection views and associated metadata for a single object (unique Object-ID instance of Object-Type), with two observation events taken at two separately distinct times. The object time series data set is depicted as a logical grouping of data elements 310 that facilitates the automatic organization of visual data about an object. The data structure grouping of the logical elements in 310 is depicted in 311. The inventive system 100 enables the capture, organization, analysis, and communication of one or more object time series data collections for objects being documented to enable visual search, retrieval, analysis, and decision making.

The Object-ID 156 is the unique identifier which indexes all visual view data and associated metadata related to a single object whose data is captured, organized, analyzed, and communicated within the system 100. The domain processing system 130 assigns a unique ID 156 which is used by the domain processing system 130 and the object time series processing system 140 for automatic data grouping for the object. An Object-ID may be assigned to domain data without the need for creation of an object time series for that Object-ID. However, every object time series will have a corresponding Object-ID (156) and an Object-Type 154 identified in the domain data processing system 130 and domain specific database 170.

An Object-ID 156 uniquely associates time series view and associated metadata data and domain data together to reference a single, unique physical object in the real world. The object can be any physical object or group of physical objects that can be sampled visually, and whose status or change over time is of interest for the purpose of visual search, retrieval, analysis, and decision making. It should be clear that the object may be a place, or a location, which constitutes as hierarchically organized selection of objects that in total constitute a “place-object”. It will be clear that object data associated with domain 170 and data associated with the object time series 180 can be processed as separate database collections, or can be combined and treated as a single database collection 160. Alternatively, subsets of any portion of the total collection of data for one or more objects 160 can be split as needed by the application domain, including but not limited to creating a separate database for a single object that is maintained on a controller system 200 that is managed and controlled by an individual producer or user of domain data 103 to further ensure data protection and privacy or for other reasons determined by the implementer of the domain specific system configuration.

Referring to FIG. 3, an object time series includes metadata 305 that is provided separate from visual view data collected as part of the time series. This data can be a wide range of contextual metadata related to the object, and is derived from the one-to-one relationship of the Object-ID to the Object-Type 152. The Object-Type contains the domain data aspects of the object that are important (e.g. person demographics, automobile make and model, property location, property age, property type), independent of the data elements necessary for the object time series. This metadata is used in the comparative change analysis performed by the object time series analyzer 150.

Additionally, the object time series data includes one or more observation events depicted as a logical grouping of data elements in 320A and 320B. The data structure grouping of the logical elements in 320A is depicted in 321A, and those in 320B is depicted in 321B. Each observation event captures a set of views that document the object at a certain point in time. Each observation forms a logical grouping from which additional object specific metadata can be explicitly derived. For example, if an observation of a person at a medical clinic is taking place on a certain date, then the metadata 325 about that observation can include the date of the patient visit, the office location where the visit takes place, the medical assistant assigned to the patient for that visit, and the reason for and notes associated with the patient's visit. Metadata 325 is explicitly available and associated with the object, organized automatically within the time series by a time stamp or data of observation index.

Each observation event 320A or 320B consists of a set of one or more Visual Data View Samples 330A through 330X. A single visual data view sample includes data elements that are captured, created, or derived at different points in operation of the invention. A visual data view sample also includes derived views created by processing module 670. Included in a single visual data view sample is 1) a single visual data view acquired by the visual sensor stored as a Visual Data View 350, or generated from derived view processor 670; 2) Device Metadata 360 that contains information created by the visual sensor device and which details information about the visual data acquisition and is created at visual data acquisition time, or information created from or used to create a derived view; 3) Visual Data View Contents Metadata, which includes data captured both at acquisition time and as well is generated during post processing steps 670 and/or 150; and 4) Comparative Metadata 370.1 that is generated during the analysis step 150.

A single observation event captures a predefined a collection of views that result from samples captured by the visual data sensor or sensors 210. An aspect of this invention is that the set of observation views are standardized for the particular object. This means that the nth view for one observation event captures the same visual data set as the nth view for another observation for the same particular object. The one-to-one correspondence of views within the object time series collection of observation events enables the comparative analysis of the object over time using the object time series analyzer 150. Object metadata is automatically derived from the fact that views are predefined. It can then be automatically known that certain metadata is related to specific visual data views. The object time series processing system 140 maintains data for each defined capture workflow procedure 151, the steps in each capture workflow procedure, and the metadata defined for each step in the capture workflow procedure.

Additional metadata is automatically associated with each visual data view. It is well known that a wide range of visual data capture devices will associate metadata with the visual data captured by that device. Thus metadata may be generated in a number of different formats, including the visual data view header (e.g. Exif or other format) record information, ICC color profile information, or embedded keywords, watermarks, or security stamps placed in the visual data at time of capture. For example, digital cameras record a data of capture timestamp, exposure, shutter speed, ISO level, and other data specific to the capture a single image. Additionally, it is well known that devices can capture location using GPS, or allow users to enter keywords directly into captured visual data, or remotely access other database related metadata for association with the visual data. Device specific metadata is related one-to-one with the visual data captured 350. All device specific metadata 360 that is provided by default by the workflow structure capture procedure device 102 is coupled with each corresponding visual data sample 330A through 330X or 340A through 330X. Metadata that is created through algorithmic processing of low-level data, high-level data, or other visual view data processing approach is contained in 365, associated with the corresponding visual data view. It will be appreciated that the various data items specified in FIG. 3, including the visual data, and any metadata or combination of visual data and metadata, can be stored in a variety of manners, included directly with or encoded into the visual view data, as a header to the visual data view file, in a separate file stored as text or structured XML, or in a database encoded for optimum performance of search and retrieval.

A further aspect of the invention is that since a predefined workflow structure and procedure is employed for the capture of views within a single observation for a specific object, the device settings can be programmatically set by the object time series processing system 140 using settings stored in the capture workflow list and metadata table 151. In this case, metadata is not discovered or programmatically generated by the device in totality after the visual data collection is complete, but are provided as predefined device settings that enable the device to repeat observation event visual data collection with repeatability and consistency from one visual data sample to the next.

Regarding FIG. 3, the object time series data set additionally contains metadata that is generated as a result of processing by the object time series analyzer 150. Metadata 370.1 generated by 150 is associated with the corresponding visual data view sample of the observation event. In the first observation event 320B, there is no comparative metadata in 330A. This is based on there being no basis of comparison for the first collection of views in the first observation event. In the second observation event 320B, each visual data sample 340A through 340X contains comparative metadata 370.1 associated with each visual data view. This comparative metadata is based on comparing using the object time series analyzer (FIG. 8) visual data view data and associated metadata in observation 2 320B with observation 1 320A. Included in the comparison are the observation event specific metadata, visual data for the view, the device metadata for the view, and the workflow procedure metadata for that step in the procedure. It should be clear that the comparative metadata can include comparison of a selected view with: 1) observations of the same object at any different time observed by the system; or 2) with reference to an object of substantially the same type. Additionally, comparison metadata can contain more than one comparison of the view with the same or reference object. For example, a single view may have comparison metadata resulting from a comparison of the object view to 2 prior observations of the same object and a comparison of the object to a reference object.

FIG. 4 is a schematic diagram of the data format for a time series data collection for a single object, with an arbitrary number “/” distinct observation events, and the associated metadata for the time series. The aspects of the object time series elements in FIG. 4 are the same as those in FIG. 3. The additional detail shown in FIG. 4 is the observation event 320I is the /th observation in the sequence for the object. Additional comparative metadata 370.1 through 370.I-1 is included with each visual data sample 340A through 340I.

A further aspect of this invention is that physical objects that are produced, created, or manufactured to a consistent set of physical specification can also be the analyzed for comparative differences. Object specific metadata 305 can be used to identify objects of the same type. For example, a baseline observation of an object of Object-Type=“automobile” and Model=“Honda Fit” and ProductionYear=“2009” can be used as a comparative observation for use in comparison with all objects in the database 160 whose object specific metadata attributes for Object-Type, Model, and ProductionYear match the same value.

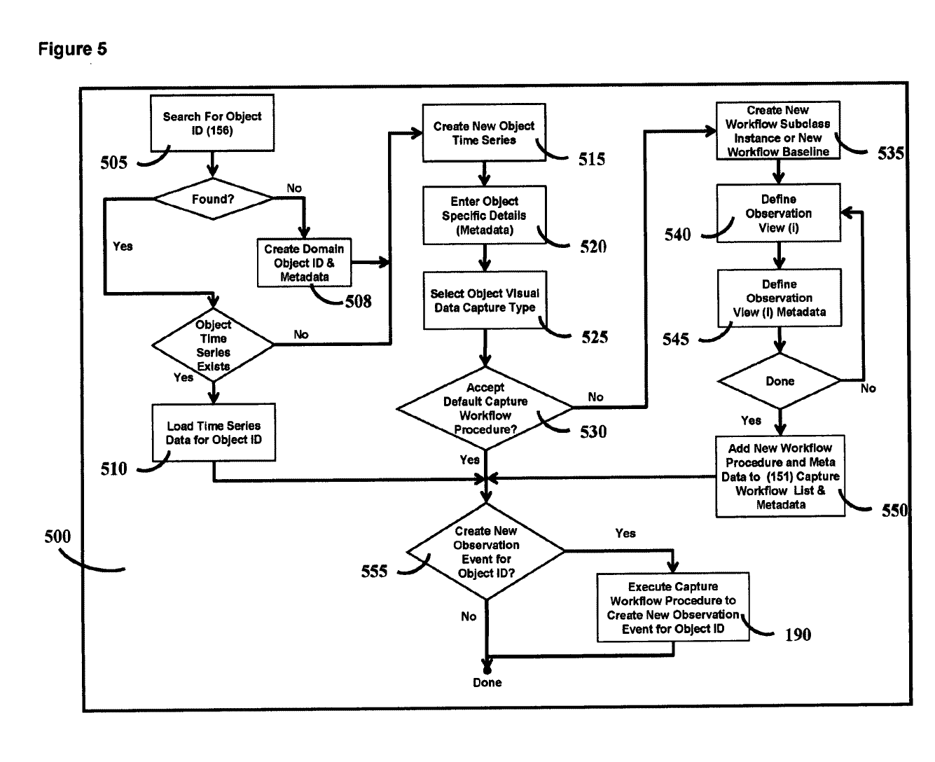

FIG. 5 is a schematic diagram detailing the procedure used to search for existing object time series and to create a new object time series if no such object-specific time series exists. Functions provided through the domain data interface 110 enable creating data about objects, organizing data about objects, processing data about objects, analyzing data about objects, editing data about objects, communicating data about objects, and so on. A key aspect of the invention is the coupling of visual view data and associated metadata captured in a time series for an object with domain data for that object, and enabling the visual view data and associated metadata to be automatically stored and organized for use by producers and users of the domain data. FIG. 5 shows how the system 100 provides domain data users with the ability to load an existing time series data for a specific object, or create new time series data for a specified object.

Through the domain data interface 110, the user can enter an ID that uniquely identifies the object. The format of the ID is dependent on the domain application. There will be a one to one correspondence between an object to be tracked and managed in the system and the ID for the object. The search procedure 505 will determine whether or not the Object-ID entered into the system exists and if there is an object time series for the object. It should be noted that the steps performed in 500 can be performed either manually through the domain data interface 110, or controlled programmatically through 105.

If the domain object does not exist in the system, through the domain data interface 110, in combination with the domain data processing system 130, the user creates a unique object 508. It will be clear that creating a new a new object instance may involve the entry of various domain specific data elements, not detailed herein. These will be specific to the application an will vary widely.

If there is no time series for the Object-ID or if the user was required to create a new Object-ID, the system presents the user with an interface to use to create a new object time series for the selected object. The Object-ID 156 is known at this point, as well as any metadata contained in the domain data system 170 already associated with the Object-ID. Metadata details needed for the time series are added in step 520. The known metadata can automatically populate the corresponding fields in the object time series. In addition to metadata known about the Object, metadata about the creation of the time series is captured in step 520. Object time series metadata may additionally include information such as time-stamp for the time series creation, operator user name and demographics, annotations about the need for the time series, and so on. Metadata global to the time series is not limited to only these examples.

Based on the type of object being visually documented (Object-Type 135), and based on the range of possible workflow capture procedure devices available, a specific visual data capture workflow structure procedure is selected 525.

In step 530, the default visual data capture workflow procedure may be reviewed and accepted if appropriate for the selected object. If the default procedure is acceptable, the predefined sequence of visual data views to be captured, and the metadata detailing what each of those steps are can be used. If the default visual data capture workflow procedure is not appropriate, the user can create a modified version of the capture workflow procedure. The capture workflow procedure can be a modified version of the existing workflow or a newly created workflow baseline 535. The user can, through the domain data user interface 110, in conjunction with the object time series processing system 140, create the new capture workflow procedure views 540 and the metadata associated with the new views 545.

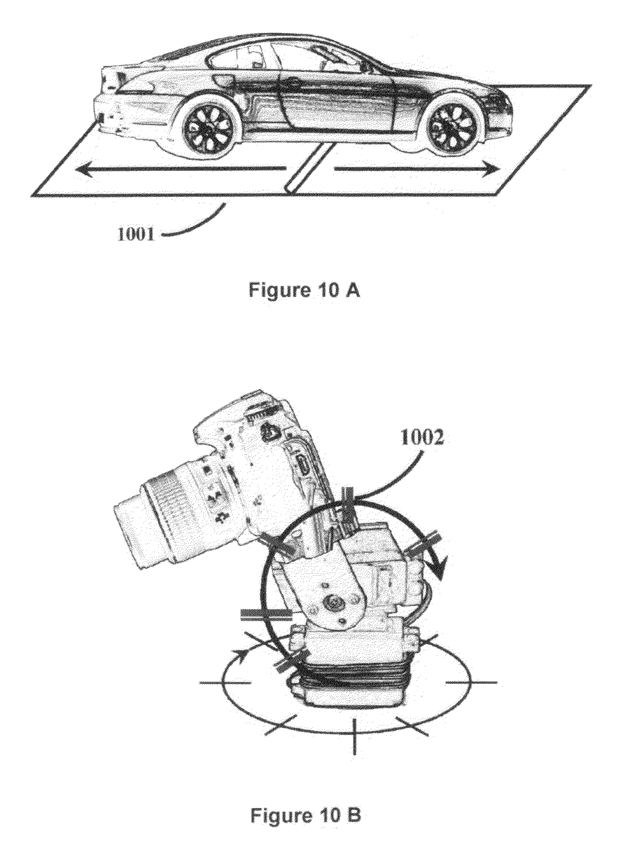

Illustrations in FIGS. 9, 10, 11, 12 and 13 show several possible options for the workflow structure capture procedure device, and the manner in which one or more views can be captured. In particular, in FIG. 9 a workflow structure procedure used to capture one or more views with a single imaging device operating sequentially and under manual control is shown. A manually positioned visual data capture sensor mounting arm or a free-hand visual data capture sensor positioning can be used to step through a well defined sequence of views to be captured. In FIG. 10, a workflow structure procedure used to capture one or more views with a single imaging device operating sequentially and under programmatic control is shown. In one case 1001, the sensor scans the underside of an automobile, enabling the comparison of the same automobile over time, or comparison of relative differences in the underside of automobiles of the same type by comparison to a reference object. A single view is aggregated from the individual line sensor outputs captured as the sensor scans underneath the auto utilizing the derived view processing provided by 670. In the second case 1002, a visual data capture sensor is mounted on a programmable pan-tilt head that controls the composition or position of the view to be captured by the visual sensor. In this example, a predefined workflow may consist of scanning horizontally in 45 degree increments for each of five different vertical settings in 45 degree increments. Again, the workflow structure capture procedure will detail the processing steps required to create derived views by 670.

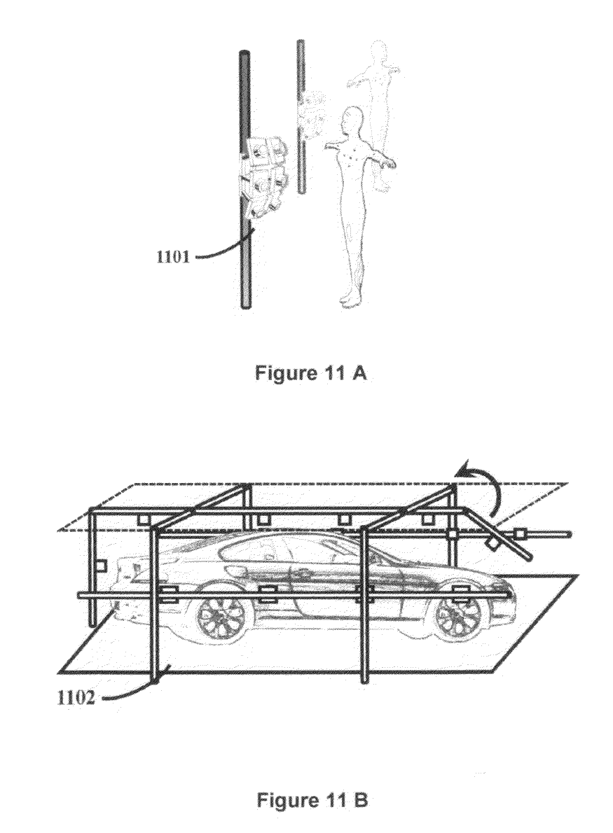

In FIG. 11, a workflow structure procedure used to capture one or more views with a single imaging device that includes multiple imaging device components operating substantially simultaneously, under programmatic control. In 1101, the workflow structure capture procedure includes both visual data view processing from the multiple sensors, and workflow structure procedure steps that specific the positioning of the object to be visually documented by the system. In 1101, the visual data view sensors work together to simultaneously capture sub-points of a single, super resolution view the entire object. The separate views captured simultaneously area processed to create a single, perspective and geometrically correct view of the entire object, using processing step 670. Additionally, using additional post processing in step 670, derived views of the object can be created. In the case of a person, the derived views may include “Head-Lateral-Left”, “Head-Lateral-Right”, “Chest-Anterior”, and so on. Further in this case, the workflow structure capture procedure will include the sequence of views that will be captured of the object (object poses), such that the object will be repositioned for the system to capture the next collection of views. So the object poses may include 4 or 8 predefined views, including “Front”, “Back”, “Left”, “Right”, etc.

In 1102, the multiple imaging devices operating substantially simultaneously comprise a series of views of the sample from different positions. The positioning of the views enables the capture of all, or substantially all regions of interest on the object.

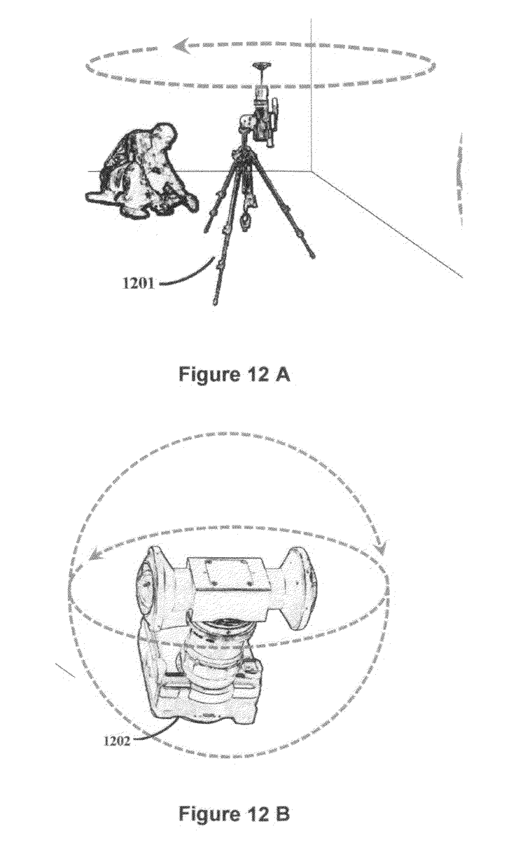

In FIG. 12, a workflow structure procedure used to capture one or more views with a single imaging device that captures a single large image from which view areas that are a subset of the larger image may be derived. Both 1201 and 1202 illustrate panoramic or omni-directional imaging devices that capture a view that covers up to 360 degrees in an X & Y axis and up to 180 degrees in a Z axis. Visual data views captured from these devices enable the capture of an entire object (e.g. a room or a position on a national border front or the entrance to a bank, etc.) in a single view. In the case of 1201, a reflective parabolic mirror captures a 360 degree view in a single view. In the case of 1202, a single sensor captures 2 opposing 180 degree views through a fisheye lens. In 1201, derived views may be extracted directly from the single view. In 1202, derived views may be extracted directly from the single view, with processing taking into account views that span the boundaries of the two individual 180 degree fisheye projections on the single captured view.

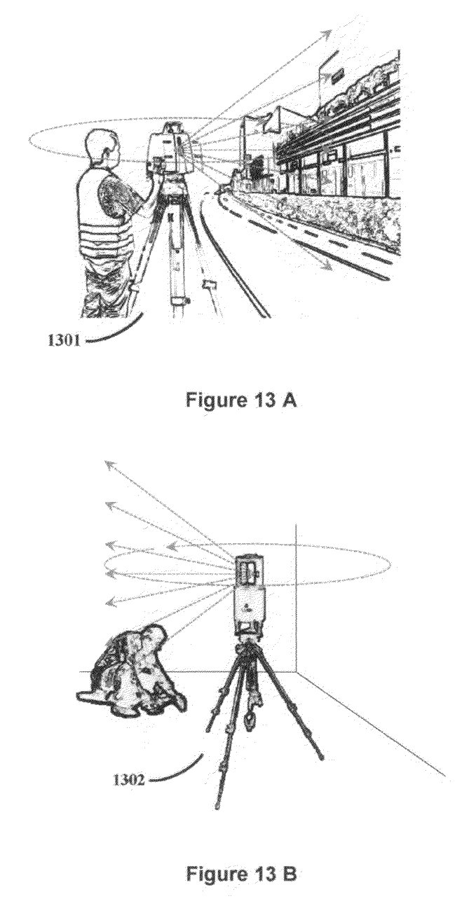

In FIG. 13, a workflow structure procedure relies on an imaging device that captures a 3D data set from which virtual view areas that are a subset of the 3D data set may be derived. A variety of methods can be employed to capture a 3D data set that samples the geometry of an object. Both 1301 and 1302 employ laser ranging and sensing devices to capture geometry. Various other possible devices to capture 3D data sets include photo-metric or stereo imaging, laser scanning, or a structured light system, or a coordinate measuring machine (CMM). In each of these cases, processing provided by 670 includes the well known techniques for the conversion of sampled points to NURBS or polygon mesh format. In additional to geometry data, visual view data may be captured to provide additional data to represent the status of the object being documented. In this case, the workflow structure capture processing procedure includes the specification of a standardized set of 3D virtual views that are derived from the data set captured.

Regardless of the device type utilized in the capture workflow procedure 190, what is specified in 540 and 545 are 1) the standardized sequence of views to be captured; 2) the metadata associated with each step (i.e. the view name and various context information associated with the step); 3) positioning directives for the object is required and the metadata for the positioning; 4) the processing steps to be applied to the source views captured by the device to create derived views; 5) the listing of each the derived views to be generated and the associated metadata to be associated with each derived view and the collection of derived views in total.

When the workflow structure capture procedure is updated with the appropriate sequence of views, the newly created workflow procedure and metadata are stored in capture workflow list and metadata component 151 of the object time series processing system 140.

In 555, the user can continue in the object time series processing by initiating the capture of a new object time series collection of views of the object by performing step 190. Otherwise, the system has been initiated so that all system configuration steps are complete in order to perform an object time series collection of views of the object at some future time.

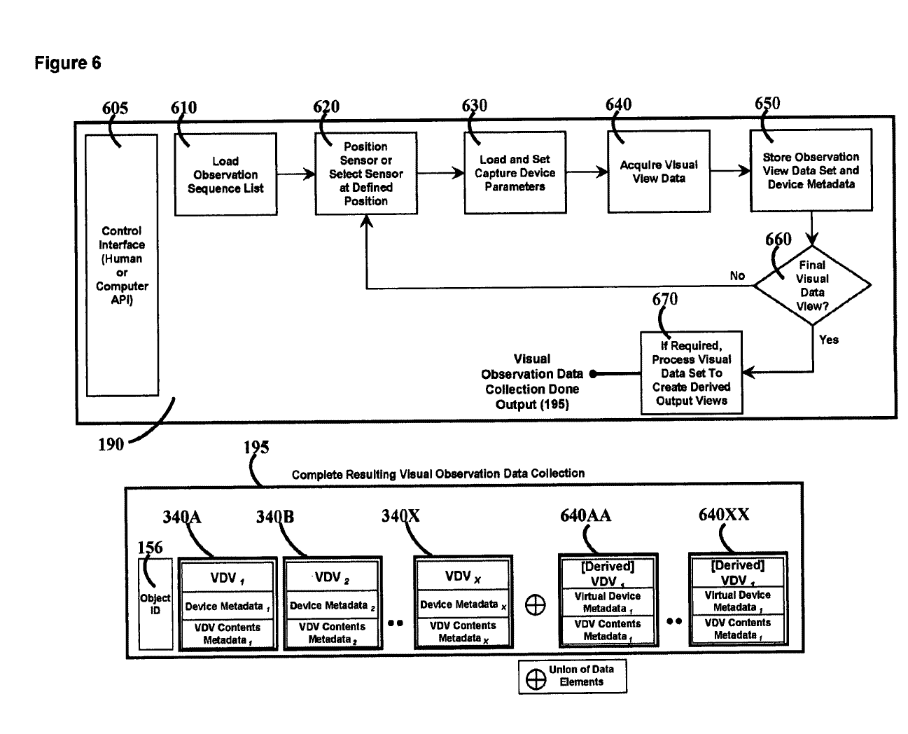

FIG. 6 is a schematic diagram detailing the procedure used to capture a single visual data observation event of an object, resulting in the acquisition of a collection of related views of the object and the metadata associated to each of the views and of the details related to view collection device. The workflow structure capture procedure can be embodied in a system which is computer controlled and performs all observations of the object programmatically, as in 1001 or 1002. In an alternative embodiment, the capture workflow is performed manually via a step-by-step processing by a human operation, as in 901 or 902. Other embodiments may provide for a combination of computer controller and human control.

The control interface to the capture workflow procedure 605 provides the logical interface to either the computer or human controller. In the case of a computer controlled interface, the interface 605 consists of a series of commands that will effect the sequence load 610 of the view steps and associated metadata, the sensor positioning 620, the device setup 630, the actual acquisition of the visual data 640, the storage of the visual data capture results and metadata generated by the device for that specific visual data capture 650, the repeating of additional visual data view captures, and once complete, the processing the captured collection of visual data views into any needed derived output views 670.

If the control interface is a human controlled interface, each of the same processing steps are performed, but the sensor positioning 620 is performed manually, and the other processing steps 610, 630, 640, 650, and 670 are performed via user based commanding of the capture device via a user interface.

The processing of visual data views to create derived views in module 670 is performed according to the steps initialized in the 535, 540, and 545, as previously described.

The collection of data created from step 190, as depicted in FIG. 6, 195. This illustration depicts the logical data grouping of the data elements which are forwarded to the processing system 120 for further processing, including time series analysis 150, and for storage as needed in either the domain specific database 170 or the object time series database 180.

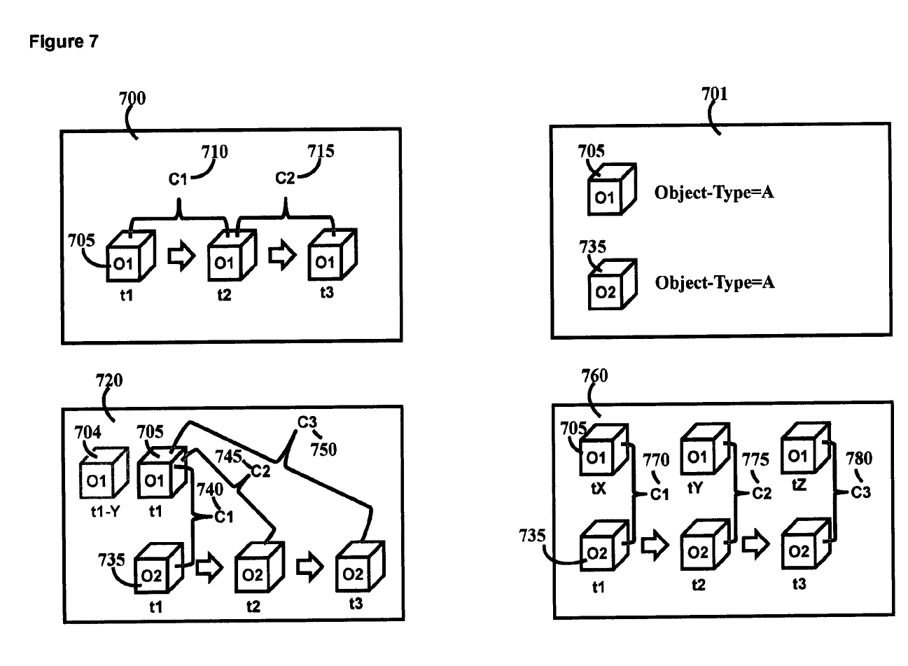

At this point, whether an object has a single time series collection of views and associated metadata or multiple time series collections of views and associated metadata, the user 103, whether they are a domain data producer or a domain data user, can access the system to perform search, retrieval, analysis and communication functions within the domain related on the object using the domain data interface 110. The user, depending on the permissions authorized by the system, may be able to: 1) perform per-view analysis, either manual or programmatic, to create new metadata information about the view; 2) find object views of a certain type based on a metadata item value; 3) find all object views with a particular feature specification; 4) perform a comparative analysis of one object relative to the same object at a prior point in time; 5) perform a comparative analysis of one object relative to the another similar object used as a reference; 6) capture additional views of the same object; 7) capture new views of a different object. The possible forms of comparison are detailed in FIG. 7. Examples of the approaches used to perform comparative analysis are detailed in FIG. 8.

FIG. 7 illustrates the several possible options for visual comparative analysis of an object over time. Note in FIG. 7, O1 and O2 represent an object and the collection of one or views and the associated metadata for the views of the respective object, as well as metadata associated with the object itself and the observation of the object based on the workflow structure capture procedure 190 and data structure 310. For the purposes of discussions about FIG. 7, note in 701, object O1 705 and object O2 735 as of the same or similar type Object-Type “A” for purposes of comparison.

In the first case 700, a single object O1 705 is visually documented over time, with visual data views captured at times t1, t2, and t3. As a result of the three distinct observation event based visual samplings of the object O1, two different comparisons C1 710 and C2 715 are determined. Comparisons are determined in this example of one sample with a prior sample. That is, O1 at t2 is compared visually with O1 at t1, and O1 at t3 is compared with O1 at t2. Clearly, it is also possible to compare O1 at t3 with O1 at t1, but for purposes of simplicity of illustration, these non-previous sample comparisons are not illustrated.

FIG. 7 further illustrates the visual comparative analysis of a single object O1 705 that is of the same Object-Type as object O2 735, as shown in 701. Because O1 and O2 are of the same Object-Type, a comparative analysis of one of the two objects (O1 or O2) can be made relative to the other. Two cases are described. In the first case, as shown in (720), a single reference visual time sample of O1 705 is used for comparison against multiple visual time samples of O2 735. Visual time sample for O1 705 is this case is taken as a baseline reference against which changes in O2 will be determined. As depicted in the 720, the observation event time for O1 is t1 for 705. This corresponds with the sample time of the first observation event for O2. The time for the reference object O1 does not need to correspond to the sample time for O2, as depicted by the optional O1 sampled at some arbitrary previous time before t1, t1-Y, as shown in 704. In either case, a comparison can be made between O1 and O2 at time t1, resulting in a comparison C1 740. Further, additional visual data samples of O2 can be compared to the baseline reference observation of O1 705 or 704 to generate additional comparisons C2 745 and C3 750.

The second case in which one object can be used to perform a comparison of another object of the same Object-Type, is shown at 760. In this case, multiple observation events of reference O1 705 are compared against multiple observation events of O2 735. In this case, there is a corresponding progression in time for the observation events for each of the objects, and the comparison are performed on the corresponding next observations for each object. Assuming again that O1 is the reference object, note in 760 that the observation events for O2 735 are taken at times t1, t2, and t3. The observation times for the reference object (O1) do not need to correspond directly to the observation times of O2. In fact, the observation times for the reference object are stated at tX, tY, and tZ. The times corresponding the observation events of the reference object O1 can correspond not only to fixed or variable times, but also to specific times related to the domain specific processing of the object. For example, a system that documents the manufacturing of an automobile may capture observation events based on the steps in the build procedure. These steps may be executed independent of any fixed times and driven through the programmatic API (105). In either case, the series of comparisons C1 770, C2 775, and C3 780 are generated.

FIG. 8 is a procedure overview of the high level algorithm used for the analysis of object time series data collected from a new observation event compared to previous observation event data collected for the same unique object at previous points in time. In the procedure 1300, two objects of the same or substantially similar Object-Type values are selected for the comparison. In this case, object O1 of Object-Type “A” is compared with another object O(i) also of Object-Type “A”. Note per the previous discussion concerning FIG. 7, object O(i) may be O1, in which case the comparison corresponds to the case depicted in 700. Otherwise, with O(i) not being the same object and O1, the choice of which observation event for O(i) will depend on if a single reference observation 720, or single observation selected from a sequence of observations of O(i) is used as in 760.

Analysis performed by 1300 can encompass a variety of possible embodiments, not only focused on comparative change analysis. For the purposes of this discussion, the focus will be on the aspects of comparative analysis that may be embodied by the invention. At a high level, comparative analysis is performed using a variety of techniques either well known for visual data image processing, or well known for mathematical, statistical, and sampling analysis.

Comparative analysis may be performed on the view data, the metadata associated with the view data, or the object view data and associated metadata together. In the case the comparative processing is to be performed on the view data, either alone or in combination with the metadata, view data preprocessing is performed in 1307A and 1307B. View data preprocessing performs steps needed to ensure that variations in the physical placement of either the capture device or the object within a particular view are match visually as closely as possible to one another. These preprocessing steps are performed on a single matched view pair from object O1 and O2. Processing to register the individual views of object O1 with that of object O2 include but is not limited to: 1) translation, rotation, perspective, or affine registration; 2) correction for parallax error; and 3) correction for curvilinear distortion (barrel or pincushion). The transformation matrix or steps resulting from processing to determine the transform of one object's view to the other object's view itself becomes metadata for the respective view. Additionally, processing may take place separately on the individual view or views of either object O1 or object O2. For example, a processing of a single view may include, but not be limited to the following: 1) separate the object in the view for the background; 2) create a mask for the outline of the object; 3) breakdown the object in the view into constituent contiguous or non-contiguous regions 4) create an outline mask for each identified contiguous or non-contiguous region; 5) identify the object or the object regions; 6) calculate the spatial relationship of the object and the identified constituent regions to one another; and 7) perform statistical and comparative analysis on pixel within the object, the constituent regions individually and relative to one another. Additionally, the transformation matrix, mathematical results, comparative tables, or other data results resulting from processing of an individual object becomes metadata for the view.

The object view data for O1 1305 and the object view data for O2 1310, in addition to the results for the preprocessing of the individual object views and the registration of O1 and O2 obtained from 1307A and 1307A are inputs to additional comparative processing performed by 1315. Possible comparative analysis steps are listed in 1315. The possible comparative steps performed include, but are not limited to: 1) low level image view data; 2) high level image view data 3) object-id domain and object type hierarchy; 4) observation event metadata; 5) visual data capture device metadata; 6) workflow procedure and procedure step specific metadata; 7) derived subset view or virtual view from 3d dataset metadata; 8) user-entered view annotations; 9) data creation or storage devices linked or associated programmatically or via a database to the view; and 10) combinations of the above. The data results resulting from these comparative analysis steps become becomes additional metadata for associated with the view.

The total results for each of the comparisons between the data and metadata for the two objects is then further processed by 1320. This step will perform the following, but not be limited to, identify duplicate data, eliminate or tag data that does not meet certain upper or lower boundary conditions, analyze distribution of results, and so on. Again, a wide variety of well known visual data image processing, mathematical, statistical, and sampling analysis procedures can take place. The data results resulting from these this steps become becomes additional metadata for associated with the view. All object comparative metadata now associated with their respective views, along with all object view time series data and metadata, created as a result of the workflow procedure enable the search, retrieval, analysis, and communication features of the invention 100, as per the requirements for the users in the particular application domain.

As previously discussed above, the following details possible devices used for the capture of visual data views of an object over time. FIG. 9 is an illustrative diagram showing several options for devices used to capture one or more views in the workflow structure that relies on a single imaging device operating sequentially, under manual control. FIG. 10 is an illustrative diagram showing several options for devices used to capture one or more views in the workflow structure that relies on a single imaging device operating sequentially, under programmatic control. FIG. 11 is an illustrative diagram showing several options for devices used to capture one or more views in the workflow structure that relies on a multiple imaging devices operating substantially simultaneously, under programmatic control. FIG. 12 is an illustrative diagram showing several options for devices used to capture one or more views in the workflow structure that relies on an imaging device that captures a single large image from which view areas that are a subset of the larger image may be derived. FIG. 13 is an illustrative diagram showing several options for devices used to capture one or more views in the workflow structure that relies on an imaging device that captures a 3D data set from which virtual view areas that are a subset of the 3D data set may be derived.

To illustrate the operation of the invention, consider the case of a dermatology practice performing total body photography for the documentation of changes in the human skin over time. In the following, the words invention and system are interchangeable.

Documenting changes to a person's skin is not a simple process. The skin is the largest of all human organs. Depending on the visual documentation sensor 206 used, documenting the human skin may require a capture workflow procedure 190 with up to 36 or more steps. For example, by using a hand held sensor 902, the domain data producer 103 will step through an exact sequence that will capture the required number of visual data views 340A-340X. The workflow capture procedure can vary depending on the needs of the domain data users. In this case, a dermatology medical practitioner may, based on experience, use a 17 view procedure. Another practitioner may be used to a 24 view procedure. Regardless, the capture workflow procedure is stored in the system 151 and it defines the steps taken by the domain data producer.

In the case of the 17-view workflow capture procedure, the workflow list and metadata 151 is defined to include each step, the step name, description of the step, visual or text based notes for capture of the step, or any other metadata determined to be important to the domain data producer. Optionally, the metadata can include specific settings that could be used to programmatically control the sensor position 620 and parameters 630 in the case the workflow capture device supports programmatic control.

The 17-view workflow list includes, for example,

Step: “1”
Name: “Head-Lateral-Left”
Description: “Patient's right side of face, below neck line to top hair line, inclusive”
Note: “60 mm Macro lens, portrait mode, sagittal plane reference to right in view”
Settings: “Auto”

Step: “2”
Name: “Head-Lateral-Right”
Description: “Patient's right side of face, below neck line to top hair line, inclusive”
Note: “60 mm Macro lens, portrait mode, sagittal plane reference to left in view”
Settings: “Auto”

Step: “3”
Name: “Chest-Anterior”
Description: “Patient's chest, above neck line to superior transverse plane”
Note: “60 mm Macro lens, landscape mode, superior transverse plane reference to bottom in view”
Settings: “Auto”

The system supports multiple capture workflow procedures. The 24 step procedure can be defined, using the procedure steps detailed in steps 535, 540, and 545.

Once the workflow procedure is defined, the system enables visual data based decision making as follows.

For the patent requiring the visual tracking of skin changes over time, the patient's skin is the object to be visually documented over time. In the case of a dermatology practice, the domain data producer may be a clinical assistant (operator) who will be tasked with entering necessary information and performing the 17-view visual data capture procedure using the system. The operator uses the domain data interface 110 to perform all activities supported by the system.

First, the operator determines whether or not the Object-ID is in the system 505. In this domain, the Object ID may be the electronic medical records chart # or the patient's social security number. The Object ID will uniquely identify the patient's domain specific data 170 and time series data 180 within the system. When the patient is first entered into the system, an Object ID 156 is created within the domain database (see step 508). Additionally, patient information 305, which can include demographic information such as name, date of birth, home address, and insurance provider is captured and stored in the domain specific database 170. If the patient exists in the system, the patient information 305 can be automatically obtained and if needed, it can be updated.

Next, the system determines if the Object-ID has an associated time series. If the time-series does not exist, an object time series data collection 311 is created 515. For this example, the capture workflow procedure “17-view” exists in the system and is accepted for this patient 530. Note that each object time series 311 is tied to one specific capture workflow procedure, contained in the list of possible capture workflow procedures in 151. An Object-ID may have more than one time series type associated with it, and the domain data interface provides the operator with the necessary information to either select one of the existing time series types existing for the Object-ID or to create the new one.

Once the object time series is loaded, a new visual observation event is created. In this case, the patient's skin is being documented for the first time as a baseline reference. The first observation event created 320A will have 17 views captured, per the selected capture workflow procedure type. The observation event itself has metadata 325A associated with it, including the time and date of the observation and the name and id of the operator performing the data collection. As well, other time-specific information that may be significant based on this particular domain application may be captured, including notes provided by the operator or by the patient.

Through the domain user interface 110, the operator is presented with a step-by-step walkthrough of the capture procedure. Since in this example, the operator is manually capturing each view, the step begins with Step 1, “Head-Lateral-Left”, and instructs the operator to position the sensor to capture the view 620. Predefined settings are loaded 630, and the operator captures the visual view data 640. At this point, the first visual data is captured, it is known to be a view of the “Head-Lateral-Left”, and the metadata settings of the sensor device can be coupled to the visual view data captured and stored as the first Visual Data View 330A. The system continues stepping through the capture procedure 660 until all 17 visual data views of the capture workflow procedure are captured. This completes the time series capture of the observation event.

Now in a follow up visit, say, three months later, the same patient is schedule for a comparative review of the changes to the skin. In this case again, the patient ID references the domain specific data and time series data, reference by the unique Object-ID. Through the system user interface 110, the time series data is loaded and a new observation event is created 555 for this visit, resulting in the data set 320B. Since the 17-view capture workflow procedure was previously used for the initial baseline collection of visual view data, the 17-view capture workflow procedure is now repeated. As before, the 17-views are captured, creating in this case creating Visual Data View 340A through Visual Data View 340Q, totaling 17 separate views.

At this point, two separate observation events, the baseline and the 3-month follow up, are stored in the system. Each observation consists of 17 views, and the i-th view of the baseline matches the i-th view of the 3-month follow up.

The system now will enable either a domain data producer, or a domain data user to access the object time series analyzer function 150 and perform a comparative analysis of the visual observation events. The analyzer 150 can be invoked by the user either through the individual selection of a particular sub-function, or automatically in one or more predefined sequences.

I claim:

1. A method for organizing visual data comprising the steps of:
defining a workflow structure;
capturing a series of views;
associating each of said views with metadata, wherein said metadata includes data derived from a comparison of said views and their associated metadata at selected points in said workflow; and,
creating a searchable database of said metadata.

2. The method of claim 1 wherein said workflow structure comprises a series of views of the same object taken at different times.

3. The method of claim 2 wherein said workflow structure comprises a series of views at each of selected different locations on a selected object.

4. The method of claim 2 wherein said workflow structure further comprises at least one view of a similar object at least one time.

5. The method of claim 1 wherein said series of views are captured by a method selected from the following group: capturing images from multiple imaging devices operating substantially simultaneously; capturing images using a single imaging device operating sequentially: selecting view areas that are subsets of a single larger image; and, selecting virtual views representing portions of a 3D data set.

6. The method of claim 1 wherein said metadata are used to define authorized classes of users.

7. A method for user retrieval of visual data, comprising:
searching a database, wherein said database comprises:
a series of views in a defined workflow structure, and
metadata associated with each view in said series of views, wherein said metadata includes data derived from a comparison of said views and their associated metadata at selected points in said workflow; and,
retrieving at least one view.

8. The method of claim 7 further comprising the step of authorizing access to at least a portion of said database by said user based on said metadata.

9. The method of claim 7 wherein said visual data retrieved includes at least some of the metadata associated with any view retrieved.

10. The method of claim 7 wherein said workflow structure comprises a series of views of the same object taken at different times.

11. The method of claim 7 wherein said workflow structure comprises a series of views at each of selected different locations on a selected object.

12. The method of claim 7 wherein said workflow structure further comprises at least one view of a similar object at least one time.

13. The method of claim 7 wherein said series of views are captured by a method selected from the following group: capturing images from multiple imaging devices operating substantially simultaneously; capturing images using a single imaging device operating sequentially: selecting view areas that are subsets of a single larger image; and, selecting virtual views representing portions of a 3D data set.

14. A method for analysis of visual data comprising the steps of:
searching a database, wherein said database comprises:
a series of views in a defined workflow structure, and
metadata associated with said series of views wherein said metadata includes data derived from a comparison of said views and their associated metadata at selected points in said workflow;
selecting at least two of said views and their associated metadata; and,
comparing said at least two views and their associated metadata in order to derive useful information therefrom.

15. The method of claim 14 wherein said useful information becomes further metadata added to said database.
